(19) United States
(12) Patent Application Publication
(10) Pub. No.: US 2025/0272770 A1
(43) Pub. Date: Aug. 28, 2025

(54) METHOD, IOT SYSTEM, AND MEDIUM FOR DISTRIBUTION CONTROLLING OF SMART GAS PIPELINE

(71) Applicant: CHENGDU QINCHUAN IOT TECHNOLOGY CO., LTD., Chengdu (CN)

(72) Inventors: Zehua SHAO, Chengdu (CN); Junyan ZHOU, Chengdu (CN); Lei HE, Chengdu (CN); Jun WANG, Chengdu (CN)

(73) Assignee: CHENGDU QINCHUAN IOT TECHNOLOGY CO., LTD., Chengdu (CN)

(21) Appl. No.: 19/207,321

(22) Filed: May 13, 2025

(30) Foreign Application Priority Data
Apr. 16, 2025 (CN) 202510473159.3

(51) Int. Cl. G06Q 50/06; F17D 5/00; G16Y 10/35; G16Y 40/30

(52) U.S. Cl. CPC G06Q 50/06; F17D 5/005; G16Y 10/35; G16Y 40/30

(57) ABSTRACT

A method for distribution controlling of a smart gas pipeline is provided, the method including: obtaining historical usage data of end-users of a target pipeline; determining a distribution demand sequence based on the historical usage data; obtaining historical monitoring data and initial gas supply parameters of a gas supply source; determining a gas consumption peak period based on the historical monitoring data; in response to determining that a gas delivery time point is in the gas consumption peak period: determining a peak regulation parameter for the target pipeline based on the distribution demand sequence and the initial gas supply parameters; and generating a peak regulation distribution instruction based on the peak regulation parameter to control the distribution control device in the target pipeline to carry out a distribution peak regulation operation in accordance with the peak regulation parameter.

### CROSS REFERENCE TO RELATED APPLICATIONS

This application claims priority to Chinese Patent Application No. 202510473159.3, filed on Apr. 16, 2025, the entire contents of which are incorporated herein by reference.

### TECHNICAL FIELD

The present disclosure generally relates to pipeline distribution, and particularly relates to a method for controlling distribution of a smart gas pipeline.

### BACKGROUND

Gas distribution refers to a complex process of separating natural gas or other gases from a trunk pipeline and delivering them to a plurality of decentralized areas or users. This process involves a plurality of stages of depressurization and distribution from a high-pressure trunk pipeline to a low-pressure customer end.

Subject to the influence of the seasons, the opening and closing of the gas users' use of the gas in different time periods, equipment failures and other factors, the gas supply is prone to interruptions, fluctuations and so on, resulting in unstable flow, low delivery efficiency and other problems, which can not fully meet the user requirements.

Thereby, a method, an IoT system, and a medium for distribution controlling of smart gas pipeline are provided, which can realize a smart control of the distribution controlling of the smart gas pipeline, and improve the stability and efficiency of gas supply.

### SUMMARY

Embodiments of the present disclosure provide a method for distribution controlling of a smart gas pipeline is provided. The method is performed by an intelligent gas gas company management platform, and includes: obtaining, through a gas company sensing network platform of smart gas, historical usage data of end-users of a target pipeline from a smart gas equipment object platform; determining a distribution demand sequence based on the historical usage data; generating a gas distribution instruction based on the distribution demand sequence and sending the gas distribution instruction to the smart gas equipment object platform to adjust a distribution control parameter of a distribution control device in the target pipeline; and obtaining historical monitoring data and initial gas supply parameters of a gas supply source through the smart gas equipment object platform; determining a gas consumption peak period based on the historical monitoring data; in response to determining that a gas delivery time point is in the gas consumption peak period: determining a peak regulation parameter for the target pipeline based on the distribution demand sequence and the initial gas supply parameters; and generating a peak regulation distribution instruction based on the peak regulation parameter and sending the peak regulation distribution instruction to the smart gas equipment object platform to control the distribution control device in the target pipeline to carry out a distribution peak regulation operation in accordance with the peak regulation parameter.

Embodiments of the present disclosure provide an internet of things (IoT) system for distribution controlling of a smart gas pipeline. The IoT system includes a smart gas government safety supervision management platform, a smart gas government safety supervision sensing network platform, a smart gas government safety supervision object platform, a gas company sensing network platform of smart gas, and a smart gas equipment object platform configured on a same server or different servers respectively. The smart gas government safety supervision management platform includes a government supervision comprehensive database, and the smart gas government safety supervision object platform includes the gas company management platform of smart gas. The smart gas government safety supervision object platform and the smart gas government safety supervision management platform exchange data via the smart gas government safety supervision sensing network platform. The smart gas government safety supervision object platform and the smart gas equipment object platform exchange data via the gas company sensing network platform of smart gas. The gas company management platform of smart gas is configured to: obtain, through the gas company sensing network platform of smart gas, historical usage data of end-users of the target pipeline from the smart gas equipment object platform; determine a distribution demand sequence based on the historical usage data; generate a gas distribution instruction based on the distribution demand sequence and send the gas distribution instruction to the smart gas equipment object platform to adjust a distribution control parameter of a distribution control device in the target pipeline; and obtain historical monitoring data and initial gas supply parameters of a gas supply source through the smart gas equipment object platform; determine a gas consumption peak period based on the historical monitoring data; in response to determining that a gas delivery time point is at the gas consumption peak period: determine a peak regulation parameter for the target pipeline based on the distribution demand sequence and the initial gas supply parameters; and generate a peak regulation distribution instruction based on the peak regulation parameter and sending the peak regulation distribution instruction to the smart gas equipment object platform to control the distribution control device in the target pipeline to carry out a distribution peak regulation operation in accordance with the peak regulation parameter.

Embodiments of the present disclosure provide a non-transitory computer-readable storage medium. The storage medium stores computer instructions, and when a computer reads the computer instructions in the storage medium, the computer performs the method for distribution controlling of the smart gas pipeline.

### BRIEF DESCRIPTION OF THE DRAWINGS

The present disclosure is further described in terms of exemplary embodiments. These exemplary embodiments are described in detail with reference to the drawings. These embodiments are non-limiting exemplary embodiments, in which the same reference numerals represent the same structures, wherein:

FIG. 1 is a schematic diagram illustrating a platform structure of an IoT system for distribution controlling of a smart gas pipeline according to some embodiments of the present disclosure;

FIG. 2 is a flowchart illustrating an exemplary method for distribution controlling of a smart gas pipeline according to some embodiments of the present disclosure;

FIG. 3 is a schematic diagram illustrating an exemplary process for determining a distribution demand sequence according to some embodiments of the present disclosure; and

FIG. 4 is a flowchart illustrating an exemplary process for controlling a gas supply of an alternate gas source in accordance with a target calling parameter according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

It should be understood that the terms “system,” “device,” “unit” and/or “module” used herein are one method to distinguish different components, elements, parts, sections, or assemblies of different levels. However, the terms may be displaced by another expression if they achieve the same purpose.

As shown in this disclosure and the claims, the words “a,” “one,” and/or “the” do not refer specifically to the singular forms but may also include the plural forms as well, unless the context clearly indicates otherwise. Generally, the terms “including” and “comprising” suggest only the inclusion of clearly identified steps and elements, and do not constitute an exclusive list, and the method or apparatus may also include other steps or elements.

Flowcharts are used in this disclosure to illustrate operations performed by a system according to embodiments of this disclosure. It should be appreciated that the preceding or following operations are not necessarily performed in an exact sequence. Instead, steps can be processed in reverse order or simultaneously. Also, it is possible to add other operations to these processes or remove a step or steps from them.

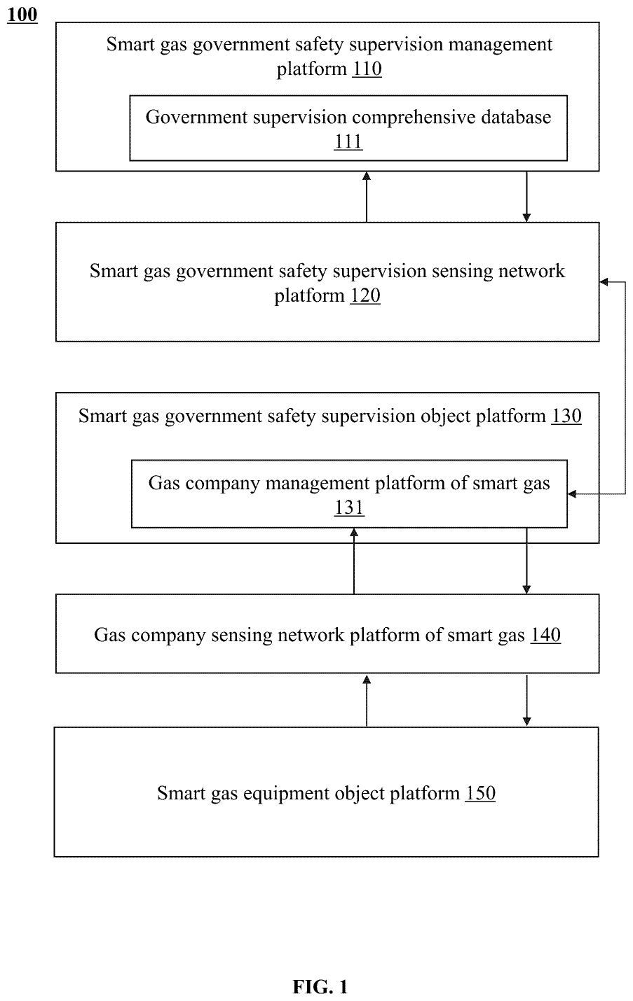

FIG. 1 is a schematic diagram illustrating a platform structure of an IoT system for distribution controlling of a smart gas pipeline according to some embodiments of the present disclosure.

In some embodiments, as shown in FIG. 1, the IoT system for distribution controlling of the smart gas pipeline include a smart gas government safety supervision management platform 110, a government supervision comprehensive database 111, a smart gas government safety supervision sensing network platform 120, a smart gas government safety supervision object platform 130, a gas company management platform of smart gas 131, a gas company sensing network platform of smart gas 140, and a smart gas equipment object platform 150.

The smart gas government safety supervision management platform 110 is a platform for supervision and safety management of gas pipelines. In some embodiments, the smart gas government safety supervision management platform 110 interacts with the smart gas government safety supervision sensing network platform 120.

In some embodiments, the smart gas government safety supervision management platform 110 includes the government supervision comprehensive database 111. In some embodiments, the smart gas government safety supervision management platform 110 may be configured in a processor and/or a server.

The government supervision comprehensive database 111 is a database for storing supervision data. For example, the government supervision comprehensive database 111 is configured to store end-user characteristics of end-users of a target pipeline, to integrate and store relevant data generated in the process of government supervision, etc.

The smart gas government safety supervision sensing network platform 120 is a functional platform that manages sensor communications of a government. In some embodiments, the smart gas government safety supervision sensing network platform 120 may be configured as a communication device, a server, etc., to implement functions of sensing communications of perceptual information and sensing communications of controlling information. For example, the smart gas government safety supervision sensing network platform 120 is configured as a communication network and gateway to implement functions such as network management, protocol management, instruction management, and data parsing.

In some embodiments, the smart gas government safety supervision sensing network platform 120 may interact with the smart gas government safety supervision management platform 110 and the smart gas government safety supervision object platform 130 of the gas company management platform of smart gas 131 for interaction. For example, the smart gas government safety supervision sensing network platform 120 may obtain the end-user characteristics of the end-users of the target pipeline collected by the smart gas government safety supervision management platform 110, and send the end-user characteristics to the gas company management platform of smart gas 131.

The smart gas government safety supervision object platform 130 is an information processing platform used by the government to carry out safety supervision of various types of supervision objects involved in gas safety, for example, the smart gas government safety supervision object platform 130 realizes generation and execution of the perceptual information and the controlling information, etc. In some embodiments, the smart gas government safety supervision object platform 130 includes the gas company management platform of smart gas 131.

The gas company management platform of smart gas 131 refers to a comprehensive platform that coordinates functional platforms of the gas company, aggregates information of the IoT, and generates and executes an instruction by analyzing and processing data/and information generated in the course of the operation of the gas company. In some embodiments, the gas company management platform of smart gas 131 may be configured as a processor, a server, etc.

In some embodiments, the gas company management platform of smart gas 131 interacts with the smart gas government safety supervision sensing network platform 120 and the gas company sensing network platform of smart gas 140.

In some embodiments, the gas company management platform of smart gas 131 is configured to: obtain, through the gas company sensing network platform of smart gas, historical usage data of the end-users of the target pipeline from the smart gas equipment object platform; determine a distribution demand sequence based on the historical usage data; generate a gas distribution instruction based on the distribution demand sequence and send the gas distribution instruction to the smart gas equipment object platform to adjust a distribution control parameter of a distribution control device in the target pipeline; and obtain historical monitoring data and initial gas supply parameters of a gas supply source through the smart gas equipment object platform; determine a gas consumption peak period based on the historical monitoring data; in response to determining that a gas delivery time point is at the gas consumption peak period: determine a peak regulation parameter for the target pipeline based on the distribution demand sequence and the initial gas supply parameters; and generate a peak regulation distribution instruction based on the peak regulation parameter and send the peak regulation distribution instruction to the smart gas equipment object platform to control the distribution control device in the target pipeline to carry out a distribution peak regulation operation in accordance with the peak regulation parameter.

In some embodiments, the gas company management platform of smart gas further includes a storage device. The storage device may store data and/or information obtained from other platforms.

The gas company sensing network platform of smart gas 140 refers to a comprehensive management platform for gas company sensing information. In some embodiments, the gas company sensing network platform of smart gas 140 may be configured as a communication device, gateway, etc., for performing functions of sensing communication of sensing information and sensing communication of controlling information. For example, the gas company sensing network platform of smart gas 140 is configured as a communication network and gateway for performing functions such as network management, protocol management, instruction management, data parsing, etc.

In some embodiments, the gas company sensing network platform of smart gas 140 interacts with the gas company management platform of smart gas 131 of the smart gas government safety supervision object platform 130 and the smart gas equipment object platform 150. For example, the gas company sensing network platform of smart gas 140 obtains the gas distribution instruction generated by the gas company management platform of smart gas 131, and sends the gas distribution instruction to the smart gas equipment object platform 150. For another example, the gas company sensing network platform of smart gas 140 obtains the historical monitoring data, the initial gas supply parameters of the gas supply source collected by the smart gas equipment object platform 150, and sends the historical monitoring data and the initial gas supply parameters of the gas supply source to the gas company management platform of smart gas 131.

The smart gas equipment object platform 150 refers to a functional platform for real-time monitoring and smart regulation of a gas pipeline network. In some embodiments, the smart gas equipment object platform 150 includes at least a monitoring device and a gas regulating device arranged in the gas pipeline network.

The monitoring device refers to a relevant device used to monitor and record an operating status of the gas pipeline network. In some embodiments, the monitoring device includes a gas flow rate sensor, a temperature sensor, a pipeline pressure sensor, in-home terminal equipment (e.g., gas meters), etc.

The gas regulating device refers to a relevant device used to control and regulate a state of the gas in the gas pipeline network. In some embodiments, the gas regulating device includes a valve, a pump station, etc.

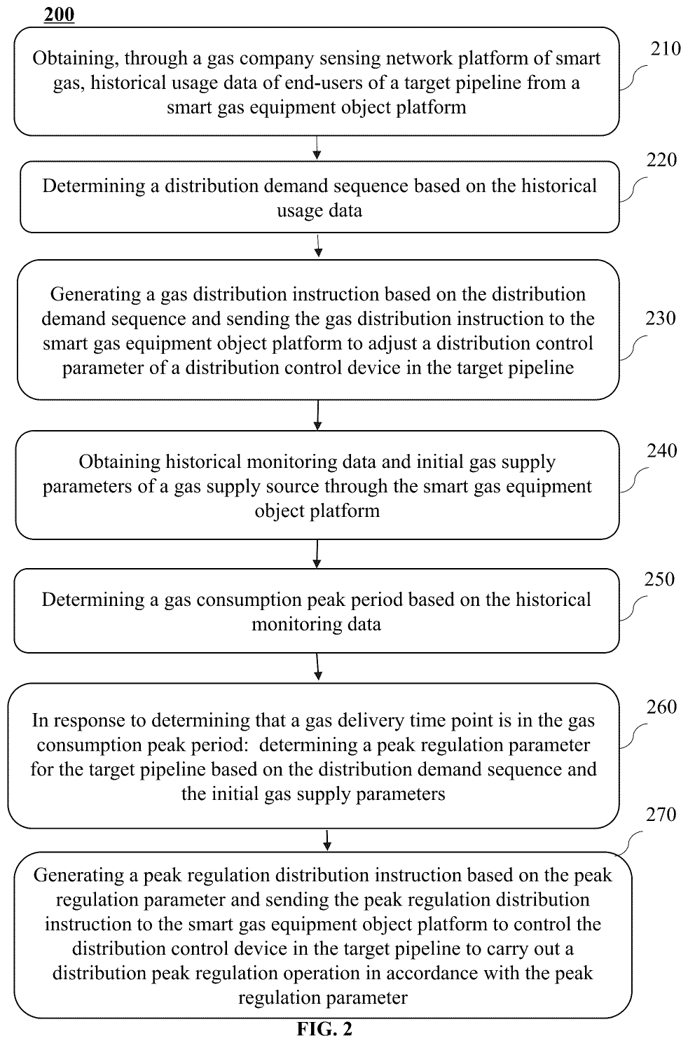

More descriptions regarding these platforms may be found elsewhere in the resent disclosure, e.g., FIGS. 2-4.

In some embodiments of the present disclosure, based on the IoT system for distribution controlling of the smart gas pipeline, a closed loop of information operation between these functional platforms is formed, and these functional platforms coordinate and operate regularly under the unified management of the gas company management platform of smart gas, realizing the informatization and intellectualization of distribution controlling of the smart gas pipeline.

It should be noted that the above description of the method, IoT sytem, and the platforms thereof for distribution controlling of the smart gas pipeline are provided only for descriptive convenience, and does not limit the present disclosure to the scope of these embodiments. It is to be understood that for a person skilled in the art, after understanding the principle of the IoT system, it may be possible to arbitrarily combine various platforms or constitute subsystems to be connected to other platforms without departing from this principle.

FIG. 2 is a flowchart illustrating an exemplary method for distribution controlling of a smart gas pipeline according to some embodiments of the present disclosure. As shown in FIG. 2, process 200 includes the following steps.

Step 210, obtaining, through the gas company sensing network platform of smart gas, historical usage data of end-users of a target pipeline from the smart gas equipment object platform.

The target pipeline is a pipeline in a gas pipeline network that needs to be monitored and controlled for gas flow rate. In some embodiments, the target pipeline includes a trunk pipeline and a distribution pipeline.

The trunk pipeline refers to a pipeline that is directly connected to a gas supply source such as a gas supply station. The distribution pipeline refers to a pipeline that is connected to the trunk pipeline for the distribution of gas from the trunk pipeline to end-users.

The end-user is a user to whom the gas in the target pipeline ultimately reaches.

The historical usage data refers to data related to gas consumption by end-users in a past time period. For example, the historical usage data includes a gas flow rate, a gas consumption time, and a count of times the gas was used in the past time period.

In some embodiments, the gas company management platform of smart gas obtains, via the gas company sensing network platform of smart gas, the historical usage data of the end-users of the target pipeline from the smart gas equipment object platform.

Step 220, determining a distribution demand sequence based on the historical usage data.

The distribution demand sequence is a sequence including gas demand parameters of the target pipeline. In some embodiments, the distribution demand sequence includes the gas demand parameters of each pipeline in the target pipeline. Merely by way of example, one element of the distribution demand sequence corresponds to a gas demand parameter of the target pipeline.

The gas demand parameter refers to data related to gas demand in the target pipeline. In some embodiments, the gas demand parameter includes a gas distribution flow demand for the target pipeline for a future time period. The gas distribution flow demand may be a specific value or a range of value.

In some embodiments, the gas company management platform of smart gas determines the distribution demand sequence based on the historical usage data in various ways. For example, the gas company management platform of smart gas takes a sum of the gas demand of the end-users directly connected to a distribution pipeline and the gas demand of a downstream distribution pipeline directly connected to the distribution pipeline, as a corresponding gas demand parameter of the distribution pipeline, and a sum of the gas demand parameters of all distribution pipelines as a gas demand parameter of a corresponding trunk pipeline.

For example, if the distribution pipeline corresponds to only one user or one downstream distribution pipeline, a gas demand of the user or a gas demand parameter of the downstream distribution pipeline may be directly obtained as the gas demand parameter of the distribution pipeline.

As another example, if the distribution pipeline corresponds to a plurality of users and/or a plurality of downstream distribution pipelines, the gas demand parameter for the distribution pipeline may be determined by combining gas demand of the plurality of users and/or combining gas demand parameters of the plurality of downstream distribution pipelines.

The sum may be a direct sum or a weighted sum. When performing the weighted summation, a higher weight is assigned to a user and/or a downstream distribution pipeline that has less gas consumption volatility. Alternatively, the weight is positively correlated to a level of the user. For example, the closer the downstream distribution pipeline is to a user end, the smaller the corresponding user level is. The gas consumption volatility is an average value of the gas consumption volatility of the end-user and/or the downstream distribution pipeline corresponding to the distribution pipeline.

In some embodiments, in order to further enhance the accuracy of the determined gas demand parameter, redundancy adjustment is performed based on the gas demand parameter determined in the manner described above. For example, an adjustment parameter is added or subtracted from the gas demand parameter determined in the manner described above, and the adjusted value or range may be used as the final gas demand parameter for the target pipeline. The adjustment parameter may be determined based on historical data or preset.

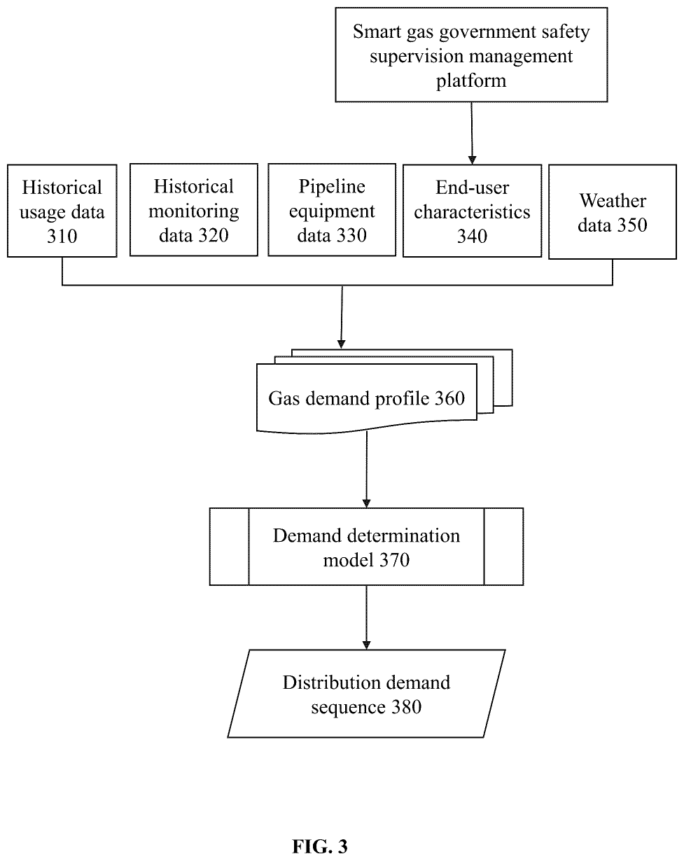

More descriptions regarding determining the distribution demand sequence can be found in the present disclosure, e.g., FIG. 3.

Step 230, generating a gas distribution instruction based on the distribution demand sequence, and sending the gas distribution instruction to the smart gas equipment object platform to adjust a distribution control parameter of the distribution control device in the target pipeline.

The gas distribution instruction is an instruction operation for gas delivery in the target pipeline. For example, the gas distribution instruction includes an instruction for regulating a gas flow rate, an instruction for regulating a gas flow velocity, etc. In some embodiments, the gas company management platform of smart gas determines the gas demand parameter of each target pipeline based on the distribution demand sequence, which in turn generates a corresponding gas distribution instruction.

The distribution control device refers to a control device used to adjust gas in the target pipeline. In some embodiments, the distribution control device includes a regulating device such as a flow regulating valve, a regulator, etc., and a control device such as a station control system PLC (Programmable Logic Controller), etc.

The distribution control parameter refers to data referenced when the distribution control device is operating. In some embodiments, the distribution control parameter includes an operating parameter of the distribution control device and the distribution demand sequence, for example, a gas flow rate limit, a gas pressure limit, a gas valve opening, a valve pressure., etc.

In some embodiments, the gas company management platform of smart gas adjusts the operating parameter of the distribution control device based on the gas distribution instruction in various ways to adjust the distribution control parameter. For example, through issuing the gas distribution instruction, the gas company management platform of smart gas adjusts the gas flow rate by adjusting the opening of the flow regulating valve and adjusts the gas pressure by adjusting the operating parameter of the regulating valve. As another example, the gas company management platform of smart gas sends the gas distribution instruction to the station control system PLC in the distribution control device, and the PLC automatically adjusts operating parameters of other regulating equipment according to the distribution control parameter corresponding to the gas distribution instruction.

Step 240, obtaining historical monitoring data and initial gas supply parameters of the gas supply source through the smart gas equipment object platform.

The historical monitoring data refers to data related to gas in the target pipeline that has been monitored over a past time period. In some embodiments, the historical monitoring data includes a gas flow rate, a gas flow velocity, a pipeline pressure, etc.

The initial gas supply parameters are gas-related data output from the gas supply source in the target pipeline. In some embodiments, the initial gas supply parameters include a gas supply volume, a gas flow rate, a gas flow velocity, a gas temperature, a gas output pressure, etc.

In some embodiments, the gas company management platform of smart gas obtains the historical monitoring data and the initial gas supply parameters of the gas supply source through the smart gas equipment object platform.

Step 250, determining a gas consumption peak period based on the historical monitoring data.

The gas consumption peak period is a time period when there is a significant increase in demand for gas in the target pipeline, for example, morning, midday, and evening.

In some embodiments, the gas company management platform of smart gas determines the gas consumption peak period based on the historical monitoring data in multiple ways. For example, the gas company management platform of smart gas counts a average value of historical gas consumption of all end-users at each time period, and determines a time period in which the average value of the historical gas consumption is greater than a preset usage threshold as the gas consumption peak period. The preset usage threshold may be set artificially or determined based on historical experience.

In some embodiments, the gas consumption peak period is prone to insufficient supply of gas, therefore, it is necessary to determine the gas consumption peak period in advance to regulate the distribution of the gas at the corresponding time point.

Step 260, in response to determining that a gas delivery time point is in the gas consumption peak period, determining a peak regulation parameter for the target pipeline based on the distribution demand sequence and the initial gas supply parameters.

The gas delivery time point is a time point at which gas pipeline distribution control is required. For example, the gas delivery time point is a preset time point, a current time point, etc.

The peak regulation parameter is a parameter related to regulating gas delivery in the target pipeline. In some embodiments, the peak regulation parameter includes a supply order in which the supply objects of the target pipeline are supplied, a gas distribution quantity corresponding to the supply of each supply object, etc. The supply object of the target pipeline includes a downstream distribution pipeline and/or an end-user to which the target pipeline is directly and correspondingly connected.

The supply order of the supply object refers to a priority of the gas supply in meeting its corresponding gas demand. The gas distribution quantity refers to a specific gas supply quantity for each supply object.

In some embodiments, the gas company management platform of smart gas determines the peak regulation parameter of the target pipeline based on the distribution demand sequence and the initial gas supply parameters in various ways.

For example, the gas company management platform of smart gas determines, based on the gas demand parameter of the trunk pipeline in the distribution demand sequence, whether or not the gas supply quantity of the gas supply source is able to satisfy the gas demand of all of the supply objects at the current time point, and if the gas supply quantity of the gas supply source is able to satisfy the gas demand of all of the supply objects at the current time point, the priority of each supply object is regarded as the same level, and the gas supply quantity of each supply object is the demand quantity corresponding to the distribution demand sequence.

If the gas supply quantity of the gas supply source is not able to satisfy the gas demand of all of the supply objects at the current time point, it is necessary to further determine the priority of each supply object, prioritize satisfying the gas demand of the supply object with high priority, and then supply gas to the supply object with the next highest priority if there is a remaining gas supply. The priority of each supply object is determined based on a predetermined setting, the volatility of its historical gas consumption, or the level of the supply object. For example, the lower the volatility of the user, the higher the priority, or the higher the level of the supply object, the higher the priority.

When the gas supply from the gas supply source is unable to satisfy the gas demand of all end-users, the gas company management platform of smart gas also determine the allocation ratio corresponding to each supply object according to the priority. The allocation ratio refers to a proportion of the total gas supply at that time point that is allocated to that end-user. For example, the higher the priority, the larger the allocation ratio.

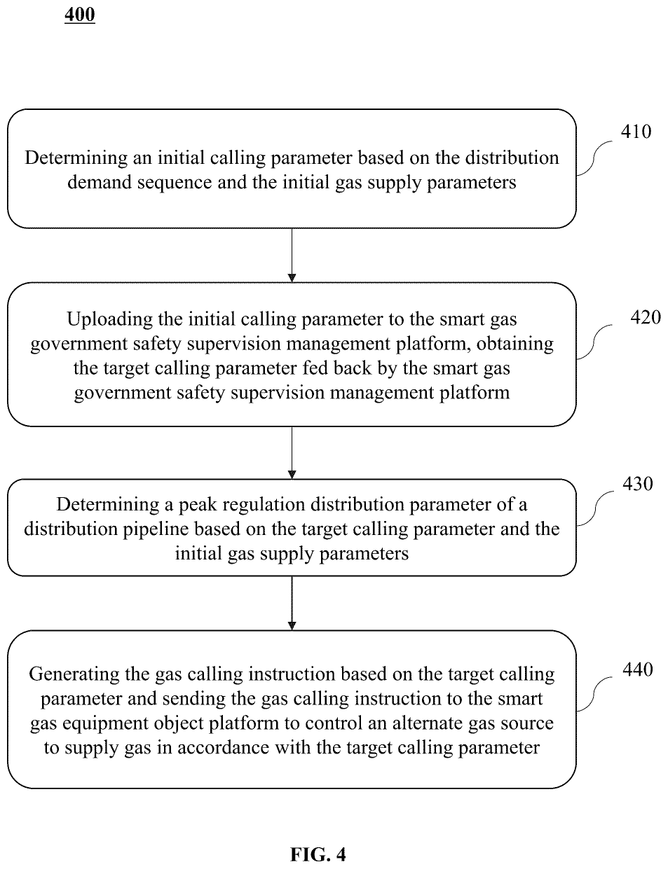

In some embodiments, when the gas supply from the gas supply source is not satisfy the gas demand of all end-users, gas from an alternate gas source is called for gas supply supplementation. More descriptions may be found elsewhere in the present disclosure, e.g., FIG. 4.

Step 270, generating a peak regulation distribution instruction based on the peak regulation parameter and sending the peak regulation distribution instruction to the smart gas equipment object platform to control the distribution control device in the target pipeline to carry out a distribution peak regulation operation in accordance with the peak regulation parameter.

The peak regulation distribution instruction is a control adjustment instruction for the distribution control device and is generated based on the peak regulation parameter. For example, the operating parameter of the distribution control device on each target pipeline is determined based on the peak regulation distribution instruction, etc.

The distribution peak regulation operation refers to an operation that realizes gas distribution of the target pipeline based on the distribution control device. In some embodiments, after the gas company management platform of smart gas sends the peak regulation distribution instruction to the smart gas equipment object platform, the smart gas equipment object platform controls the corresponding distribution control device in accordance with the operating parameter of the distribution control device in the peak regulation distribution instruction to adjust the operating parameter, and the distribution control device operates in accordance with the adjusted operating parameter to realize the distribution peak regulation operation of gas.

In some embodiments of the present disclosure, the gas company management platform of smart gas determines the distribution demand sequence based on the historical usage data of the end-users of the target pipeline, which can analyze, based on the historical actual usage of the gas by the end-users, an accurate user's distribution demand for gas; then generates the gas distribution instruction based on the distribution demand sequence, and adjusts the distribution control parameter of the distribution control device in the target pipeline. By determining the gas consumption peak period, it is possible to realize that when the gas delivery time point is in the gas consumption peak period, the peak regulation parameter of the target pipeline is determined based on the distribution demand sequence and the initial gas supply parameters, which is possible to adequately adapt to the demand for gas by each end-user.

It should be noted that the foregoing description of the process 200 is intended to be exemplary and illustrative only and does not limit the scope of the present disclosure. For a person skilled in the art, various corrections and changes can be made to the process 200 under the guidance of the present disclosure. However, these corrections and changes remain within the scope of the present disclosure.

FIG. 3 is a schematic diagram illustrating an exemplary process for determining a distribution demand sequence according to some embodiments of the present disclosure.

In some embodiments, the gas company management platform of smart gas obtains, via the smart gas government safety supervision sensing network platform, end-user characteristics 340 of end-users of the target pipeline; constructs a gas demand profile 360 based on historical usage data 310, historical monitoring data 320, pipeline equipment data 330, the end-user characteristics 340, and weather data 350; and determines the distribution demand sequence 380 using a demand determination model 370 based on the gas demand profile 360.

The end-user characteristics 340 refer to end-user related characteristic information. In some embodiments, the end-user characteristics include a user type, historical complaint information, gas consumption scale, etc. The user type may include a residential user, an industrial user, a commercial user, etc., and if the user type is the industrial user, the end-user characteristics may also include a plant type.

In some embodiments, the gas company management platform of smart gas constructs the gas demand profile 360 based on the historical usage data 310, the historical monitoring data 320, the pipeline equipment data 330, the end-user characteristics 340, and the weather data 350.

The pipeline equipment data 330 refers to information related to a gas pipeline. In some embodiments, the pipeline equipment data includes a pipeline equipment type, a pipeline inner diameter, a gas flow rate limit, a gas pressure limit, etc. The pipeline equipment data may be obtained based on historical pipeline laying records.

The weather data 350 refers to weather data of an area where the end-user is located at the current and future time points. For example, the weather data 350 includes temperature, humidity, wind speed, weather conditions, and so on. In some embodiments, the weather data is obtained according to a third-party platform, such as weather.com.

In some embodiments, nodes of the gas demand profile 360 include at least one of a pipeline node and a user node. For example, the nodes of the gas demand profile 360 include a pipeline node and a user node.

In some embodiments, node characteristics of the pipeline node include historical monitoring data and pipeline equipment data. Node characteristics of the user node include the historical usage data, the end-user characteristics, and the weather data.

In some embodiments, the node characteristics of the user node also include a gas stabilization demand. The gas stabilization demand is determined based on the end-user characteristics and parameters of usage equipment.

The parameters of usage equipment refer to parameters related to gas-using equipment. In some embodiments, the parameters of usage equipment include a type of the gas-using equipment, an age of the gas equipment, etc. The type of the gas-using equipment may be, for example, a wall oven, a gas stove, a water heater, etc. In some embodiments, the parameters of usage equipment are obtained by the user's own upload.

The gas stabilization demand is used to characterize the end-user's demand for stability of gas delivery. For example, for industrial users who need gas for product manufacturing, the stability of the gas flow rate has a great impact on product quality, and the gas stabilization demand of the industrial users is higher.

In some embodiments, the gas company management platform of smart gas determines the gas stabilization demand based on the end-user characteristics, the parameters of usage equipment in multiple ways.

For example, the gas company management platform of smart gas constructs a vector database based on a large number of historical end-user characteristics, a large number of historical parameters of usage equipment, and determines a corresponding gas stabilization demand based on a matching vector search. The vector database may include a plurality of reference feature vectors and reference gas stabilization demands corresponding to the reference feature vectors. Each of the reference feature vectors may be constructed based on historical end-user characteristics and historical parameters of usage equipment actually collected during historical daily gas consumption. For example, a reference feature vector is constructed based on a historical end-user characteristic and its corresponding historical parameter of usage equipment.

The gas company management platform of smart gas may determine a reference gas stabilization demand corresponding to each reference feature vector based on historical feedback data. For example, in the process of gas supply to the end-user corresponding to the reference feature vector, when there is a gas delivery fluctuation, if feedback such as a complaint from the user about the gas fluctuation or feedback such as a product quality fluctuation or unstable equipment status in the corresponding time period is obtained, a higher reference gas stabilization demand corresponding to the reference feature vector is considered. The gas delivery fluctuation refers to an instability of gas when the gas is delivered in the target pipeline. For example, the gas delivery fluctuation includes gas flow rate fluctuation, pressure fluctuation, etc. In some embodiments, the gas delivery fluctuation is calculated based on gas data read by a meter deployed in an in-home pipeline of an end-user. For example, the meter is a flow meter, a pressure meter, etc.

The gas company management platform of smart gas may construct a usage feature vector based on an end-user characteristic and a parameter of usage equipment corresponding to the end-user characteristic. The reference feature vector is constructed in a similar manner as the usage feature vector. In some embodiments, the gas company management platform of smart gas determines the gas stabilization demand corresponding to the usage feature vector based on a similarity between the usage feature vector and the plurality of reference feature vectors in the vector database. For example, a reference feature vector whose similarity with the usage feature vector satisfies a similarity preset condition is taken as a target vector, and the reference gas stabilization demand corresponding to the target vector is taken as the final gas stabilization demand. The similarity preset condition may be set as appropriate. For example, the similarity preset condition is that the similarity is maximal, that the similarity is greater than a threshold, etc.

Edges are used to connect nodes that have an associative relationship.

An edge feature may include a gas flow direction.

In some embodiments, the demand determination model 370 is a machine learning model. For example, the demand determination model 370 is a graph neural network model.

In some embodiments, an input to the demand determination model 370 is the gas demand profile 360 and an output of the demand determination model 370 is the distribution demand sequence 380.

In some embodiments, the demand determination model 370 is obtained by training based on a training sample dataset, and a training process of the demand determination model 370 includes an initial training phase and an intensive training phase. The initial training phase refers to a pre-training phase when a large amount of general data is used as training data when the target pipeline has not yet been accessed, and the intensive training phase refers to a personalized and customized training phase with data corresponding to the target pipeline as training data.

In some embodiments, the training data in the training sample dataset includes a training sample and a corresponding training label. In some embodiments, the training sample includes a sample gas demand profile, and the training label includes a distribution demand sequence actually collected by the training sample at a sample future time.

When training, the gas company management platform of smart gas inputs a plurality of training samples with training labels into an initial demand determination model, constructs a loss function through the training labels and results of the initial demand determination model, and iteratively updates parameters of the initial demand determination model based on the loss function through gradient descent, based on the loss function, the parameters of the initial demand determination model are iteratively updated by gradient descent or other ways. When a preset condition is met, the training of the demand determination model is completed, and a trained demand determination model is obtained. The preset condition may be that the loss function converges, a count of iterations reaches a threshold, and so on.

A training sample dataset of the initial phase is used in the initial training phase to perform training for the initial demand determination model, and a training sample dataset of the intensive phase is used in the intensive training phase to perform training for the initial demand determination model trained after the initial training phase.

In some embodiments, in the initial training phase, the training sample dataset for the initial training phase is obtained based on general data on the cloud platform. In some embodiments, the general data on the cloud platform includes data corresponding to pipelines in a plurality of districts of a city and data corresponding to pipelines in other cities.

In some embodiments, in the intensive training phase, the training sample dataset of the intensive training phase is generated from historical data actually collected by the target pipeline, and a proportion of training samples corresponding to a time period is not less than a preset threshold. The preset threshold is positively correlated to a total amount of gas delivered for the time period. The training samples corresponding to a time period are training samples consisting of historical data collected in the corresponding time period.

In some embodiments of the present disclosure, the training process of the demand determination model includes the initial training phase and the intensive training phase, and the staged training not only accelerates the training process of the demand determination model and improves the performance of the demand determination model, but also improves the prediction accuracy of the demand determination model. The intensively trained model can obtain the distribution demand sequence with higher accuracy for an actual situation within the target pipeline. Meanwhile, the distribution of gas demand may be very uneven across time. For example, gas consumption is much higher during the morning and evening peak hours. If the demand determination model is trained with too few samples for a particular time period, the demand determination model may not accurately capture the pattern of gas consumption during the time period. By ensuring that the proportion of the samples for each time period is not less than a preset threshold, the data distribution can be balanced, and the prediction accuracy can be improved.

In some embodiments of the present disclosure, the gas company management platform of smart gas determines the distribution demand sequence using the demand determination model, making full use of the property that the demand determination model accurately predicts the future gas demand by learning from historical patterns. This makes the prediction results closer to the actual situation. Additionally, the model can fuse a plurality of data sources, including the pipeline equipment data, the end-user characteristics, and the weather data, to improve the comprehensiveness and accuracy of the prediction. For example, the weather data can help predict the impact of extreme weather on gas demand.

FIG. 4 is a flowchart illustrating an exemplary process for controlling a gas supply of an alternate gas source in accordance with a target calling parameter according to some embodiments of the present disclosure. As shown in FIG. 4, process 400 includes the following steps.

In some embodiments, in order to further satisfy the gas demand of the users and to reduce the pressure of gas supply during peak periods, a gas storage reservoir is provided in the pipeline network and a gas storage device is provided in part or all of the downstream-most distribution pipeline. The downstream-most distribution pipeline refers to a distribution pipeline that is directly connected to an end-user, and the downstream-most distribution pipeline that is provided with the gas storage device may be referred to as an end gas storage pipeline. The gas storage reservoir and the end gas storage pipeline are collectively referred to as an alternate gas source.

In some embodiments, the peak regulation parameter further includes a target calling parameter, and the peak regulation distribution instruction further includes a gas calling instruction.

The target calling parameter refers to a parameter related to the alternate gas source to be called and the use of the gas it calls. In some embodiments, the target calling parameter includes a target calling object, a target calling time, a target calling gas volume, and a gas delivery object. The target calling object refers to an alternate gas source that needs to be called. The target calling time refers to a specific time for calling gas. The target calling gas volume refers to a gas output volume that needs to be called. The gas delivery object refers to an end-user to be delivered by the called alternate gas source.

In some embodiments, the target calling parameter is confirmed by the smart gas government safety supervision management platform, and the smart gas government safety supervision management platform adjusts the target calling parameter based on an actual situation, and then the adjusted target calling parameter is returned to the gas company management platform of smart gas.

The gas calling instruction refers to a gas calling and controlling instruction determined based on the target calling parameter. For example, the gas calling instruction includes a calling gas flow rate, a calling gas flow velocity, and so on.

Step 410, determining an initial calling parameter based on a distribution demand sequence and initial gas supply parameters.

The initial calling parameter refers to data related to the calling of the alternate gas source that is initially set. In some embodiments, the initial calling parameter includes a calling object, a calling time, a calling gas volume, a gas delivery object, etc.

In some embodiments, the gas company management platform of smart gas determines the initial calling parameter in a variety of ways.

For example, a net gas delivery demand of an end-user is determined based on the distribution demand sequence and the initial gas supply parameters, and the initial calling parameter corresponding to the alternate gas source is determined based on the net gas delivery demand of the end-user.

The net gas delivery demand=gas demand corresponding to the end-user-actual supply from the target pipeline corresponding to the end-user.

In some embodiments, the storage gas from different alternate gas sources has different calling priorities, such as a calling priority of the end gas storage pipeline is greater than that of the gas storage reservoir, and the gas company management platform of smart gas gives priority to controlling the end gas storage pipeline for supplemental supply of a corresponding end-user with an insufficient supply of gas, and if the storage gas of the end gas storage pipeline cannot meet gas demand of the corresponding end-user, the gas company management platform of smart gas calls the gas storage reservoir to supplement gas supply to each end-user.

In some embodiments, the end gas storage pipeline corresponds to (i.e. be directly connected to) a plurality of users, where a user with an insufficient supply of gas (hereinafter referred to as a user to be replenished) is the object for which the end gas storage pipeline is to be replenished with gas.

In the initial calling parameter corresponding to the end gas storage pipeline, the gas delivery object is the user to be replenished corresponding to the end gas storage pipeline, the calling object is the end gas storage pipeline, the calling time is a time when a net gas delivery demand is greater than 0, and the calling gas volume is determined in a variety of ways.

For example, when a gas storage capacity of the end gas storage pipeline is greater than or equal to the net gas delivery demand of the user to be replenished, the calling gas volume in the initial calling parameter of the end gas storage pipeline is a gas volume corresponding to the net gas delivery demand.

As another example, if a gas storage capacity of the end gas storage pipeline is less than the net gas delivery demand of the user to be replenished, the calling gas volume in the initial calling parameter of the end gas storage pipeline is a gas volume when controlling the end gas storage pipeline to replenish supply to the corresponding user to be replenished according to the way of equalizing the storage gas or according to the way of assigning allocation weights to allocate the storage gas.

An allocation weight is negatively correlated to a volatility of the gas consumption of the user to be replenished, and positively correlated to the net gas delivery demand and the gas stabilization demand of the user to be replenished. In some embodiments, if a gas supplementation provided by the end gas storage pipeline corresponding to the user to be replenished still fails to satisfy the gas demand of the user to be replenished, i.e., an amount of gas supplementation provided by the end gas storage pipeline is less than the net gas delivery demand of the user to be replenished, the initial calling parameter also includes an initial calling parameter corresponding to the gas storage reservoir.

In some embodiments, the gas storage reservoir is connected to a distribution pipeline and is provided at a location upstream near a trunk pipeline so that supplemental supply of gas to more end-users can be realized based on the gas storage reservoir.

In some embodiments, the gas company management platform of smart gas obtains user information of a user having a demand for supplemental gas supply from the gas storage reservoir (hereinafter referred to as an additional replenishment user), and the user information includes information such as an additional replenishment volume and a demand time point. The additional replenishment volume refers to a difference between the net gas delivery demand and a gas volume that may be supplied by the end gas storage pipeline, and the demand time point refers to a time at which there is a net gas delivery demand of greater than 0.

In some embodiments, one or more gas storage reservoirs may be provided, and if only one gas storage reservoir exists, the additional replenishment volumes of all additional replenishment users, are provided by the gas storage reservoir, then in the initial calling parameter corresponding to the gas storage reservoir, the gas delivery object is the additional replenishment user, the calling object is the gas storage reservoir, the calling time is the demand time point, and the calling gas volume of each gas delivery object may be determined in a variety of ways. For example, if the gas storage capacity of the gas storage reservoir is greater than or equal to a sum of the additional replenishment volumes of all of the additional replenishment users, the calling gas volume for each gas delivery object is its corresponding additional replenishment volume.

If there are a plurality of gas storage reservoirs, the gas company management platform of smart gas may summarize gas storage capacities of all of the gas storage reservoirs and the additional replenishment volumes of all the additional replenishment users, and if a total capacity of the gas storage capacities is greater than or equal to a total volume of the additional replenishment volumes, the gas company management platform of smart gas may determine the additional replenishment users that can be supplied by each gas storage reservoir and corresponding calling gas volume in accordance with the principle of the shortest delivery path, the principle of the lowest delivery cost, etc., so as to obtain the initial calling parameter of each gas storage reservoir.

If the gas storage capacity of the plurality of gas storage reservoirs (including one gas storage reservoir) is less than the total volume of additional replenishment volume, the gas company management platform of smart gas may, in accordance with the principle of giving priority to satisfying the additional replenishment users with high priority, first carry out gas supplemental supply to the additional replenishment users with high priority, and if there is still gas remaining, then it may further carry out gas supplemental supply to the additional replenishment users with a next highest priority until the gas storage capacity of all of the plurality of gas storage reservoirs has been allocated. Each time an additional replenishment user is replenished, if a volume of gas remaining available to be called is greater than or equal to the additional replenishment volume of the additional replenishment user, a calling gas volume for the additional replenishment user is the additional replenishment volume; if the volume of gas remaining available to be called is less than the additional replenishment volume of the additional replenishment user, the calling gas volume for the additional replenishment user is the remaining callable gas volume. The remaining callable gas volume=the gas storage volume−the determined calling gas volume, and thus the initial calling parameter is obtained for each gas storage reservoir.

Step 420, uploading the initial calling parameter to the smart gas government safety supervision management platform, and obtaining the target calling parameter fed back by the smart gas government safety supervision management platform.

In some embodiments, the smart gas government safety supervision management platform adjusts the initial calling parameter according to an actual situation, and then determines the target calling parameter. An adjustment of the initial calling parameter may include adjusting the calling gas volume or priority for a portion of the users to be replenished or the additional replenishment users, adjusting a portion of the supply volume of the end gas storage pipeline or the gas storage reservoir, etc. If the target calling parameter fed back by the smart gas government safety supervision management platform only adjusts the supply volume of the end gas storage pipeline or the gas storage reservoir, the target calling object, the target calling time, the target calling gas volume, and the gas delivery object in the target calling parameter may be adjusted, and the gas storage capacity of the gas storage reservoir and the end gas storage pipeline may be updated to be replaced with the supply volume of the end gas storage pipeline or the gas storage reservoir adjusted by the smart gas government safety supervision management platform.

Step 430, determining a peak regulation distribution parameter of the distribution pipeline based on the target calling parameter and the initial gas supply parameters.

The peak regulation distribution parameter of a distribution pipeline refers to a control parameter of the distribution pipeline, including a supply order to each of the corresponding end-users, and a distributed gas volume to the corresponding supply of each end-user.

In some embodiments, the gas company management platform of smart gas determines, based on the target calling parameter and the initial gas supply parameters, the peak regulation distribution parameter of the distribution pipeline in various ways.

For example, the gas company management platform of smart gas determines the supply order of the end-users based on the priority of the end-users, and the higher the priority, the higher the supply order. The gas distribution volume supplied to each end-user may be a sum of the volume of gas that the end-user obtains from the gas supply source and the supplemental supply of gas that the end-user obtains from the alternate gas source. The supplemental supply of gas from the alternate gas source may be determined based on the target calling parameter, and the volume of gas from the gas supply source may be determined from the peak regulation parameter of the target pipeline determined based on the initial gas supply parameters and the distribution demand sequenced. More descriptions may be found elsewhere in the present disclosure, e.g., FIG. 2.

In some embodiments, the gas company management platform of smart gas determines a distribution priority based on the gas stabilization demand and the importance degree of the user; and the peak regulation distribution parameter of the distribution pipeline is determined based on the distribution priority, the target calling parameter, and the initial gas supply parameters.

The distribution priority refers to a prioritization of supply objects determined based on the gas stabilization demand and the importance degree of the users.

More descriptions regarding the gas stabilization demand may be found elsewhere in the present disclosure, e.g., FIG. 3.

In some embodiments, the importance degree of the user is determined based on a preset rule, for example, the preset rule may be that the importance degree of an industrial user is greater than that of a residential user; the greater the average daily gas consumption of the user, the greater the monthly bill payment of the user, the longer the user has been connected to the gas system, and the more often the user pays the bill on time, the higher the importance degree of the user.

In some embodiments, the gas company management platform of smart gas determines the distribution priority based on the gas stabilization demand and the importance degree of the user in various ways. For example, the distribution priority is determined to be higher for a user with a strict gas stabilization demand, or for a user with a higher importance degree.

In some embodiments, a way of determining the peak regulation distribution parameter of the distribution pipeline based on the distribution priority, the target calling parameter, and the initial gas supply parameters is the same as the way of determining the peak regulation distribution parameter of the distribution pipeline based on the target calling parameter and the initial gas supply parameters, and the difference is that when the priority level is used to determine the information accordingly, the priority level used is replaced with the distribution priority.

In some embodiments of the present disclosure, the gas company management platform of smart gas determines the peak regulation distribution parameter of the distribution pipeline based on the distribution priority, etc., which can make that the determined peak regulation distribution parameter better meets the actual demand, realizing a reasonable distribution of gas.

In some embodiments, the gas company management platform of smart gas, when performing the distribution peak regulation operation, determines, based on actual monitoring data, whether the actual distribution parameter and the peak regulation distribution parameter satisfy a preset discrepancy condition, and/or whether the actual calling parameter and the target calling parameter satisfy the preset discrepancy condition; generates a correction instruction based on the actual monitoring data, the actual distribution parameter, and the target calling parameter in response to determining that the actual distribution parameter and the peak regulation distribution parameter satisfy satisfy the preset discrepancy condition; and sends the correction instruction to the smart gas equipment object platform to correct the operating parameter of the distribution control device.

The actual monitoring data refers to data related to the gas monitored in real time. In some embodiments, the actual monitoring data includes an actual distribution parameter with an actual calling parameter.

The preset discrepancy condition refers to a preset difference allowed to exist between the actual distribution parameter and the peak regulation distribution parameter and/or between the actual calling parameter and the target calling parameter. In some embodiments, the preset discrepancy condition is set manually or based on historical experience. For example, the preset discrepancy condition is that a variance exists or that the variance exceeds a preset range, etc.

The actual distribution parameter is data related to gas distribution monitored in real time. For example, an actual supply order of the individual end-users and a volume of gas distribution actually supplied corresponding to each end-user.

The gas company management platform of smart gas may acquire in real time the actual supply order of individual end-user and the volume of gas distribution actually supplied corresponding to each end-user, and perform a discrepancy comparison between the actual distribution parameter acquired and the peak regulation distribution parameter determined as aforesaid, and if there is a discrepancy or the discrepancy exceeds a preset range, generates a correction instruction.

The presence of the discrepancy of the gas distribution volume or the discrepancy exceeding the preset range refers to that a value of (a gas distribution volume in the peak regulation distribution parameter−gas distribution volume actually supplied)/gas distribution volume in the peak regulation distribution parameter is greater than a preset discrepancy threshold. The preset discrepancy threshold may be obtained by querying a preset table based on corresponding information of the end-user. For example, an end-user with a high gas stabilization demand is set with a lower preset discrepancy threshold.

The actual calling parameter refers to the actual call of the alternate gas source. For example, the actual calling parameter includes the actual calling time, the actual calling gas volume, and the actual gas delivery object of the gas storage reservoir and the end gas storage pipeline. The gas company management platform of smart gas obtains the actual calling situation of each alternate gas source in real time as the actual calling parameter, and performs a discrepancy comparison between the obtained actual calling parameter and the target calling parameter determined as described previously, and generates the correction instruction if there is a discrepancy.

The correction instruction refers to an instruction that corrects and adjusts the operating parameter of the distribution control device.

In some embodiments, correcting the operating parameter of the distribution control device includes correcting a valve opening, a pressure regulating parameter, a gas flow rate, a gas flow velocity, etc., of the distribution control device.

In some embodiments, the gas company management platform of smart gas generates a correction instruction based on the actual monitoring data, the actual distribution parameter, and the actual calling parameter in various ways. For example, if an actual gas distribution volume of the actual calling parameter is less than the gas distribution volume in the peak regulation distribution parameter, a valve opening of the downstream-most distribution pipeline of the corresponding end-user may be correspondingly adjusted upward.

In some embodiments, if there exists an objective limitation such as aging of the equipment, blockage of the pipeline, etc., which does not allow the actual distribution parameter to conform to the peak regulation distribution parameter, or if the actual calling parameter does not conform to the target calling parameter, the actual calling parameter may be used as a new target calling parameter, and a new peak regulation distribution parameter is determined based on the new target calling parameter by combining the distribution priority and the initial gas supply parameters, and the actual monitoring data is obtained again to make the above correction judgment.

In some embodiments of the present disclosure, the gas company management platform of smart gas generates the correction instruction based on whether or not the actual monitoring data, the actual distribution parameter, and the actual calling parameter satisfy the preset discrepancy condition with the peak regulation distribution parameter and the target calling parameter, respectively, to correct the operating parameter of the distribution control device to ensure that in the actual gas distribution process, the operating parameter of the equipment can be found and adjusted in a timely manner.

In some embodiments, the gas company management platform of smart gas determines candidate distribution parameters based on the target calling parameter, the distribution demand sequence, and the initial gas supply parameters; determines assessment scores of the candidate distribution parameters based on the candidate distribution parameters, end-user characteristics, and pipeline characteristics profile using a peak regulation assessment model; determines the peak regulation distribution parameter based on the assessment scores.

The candidate distribution parameters are the data to be identified as the peak regulation distribution parameter.

In some embodiments, the gas company management platform of smart gas takes the aforementioned peak regulation distribution parameter of the distribution pipeline determined based on the target calling parameter and the initial gas supply parameters, as initial parameters, and performs, based on the initial parameters and a pre-set step, a random adjustment within a preset limit to obtain a plurality of candidate distribution parameters. The preset limits is determined based on the distribution demand sequence, for example, a gas distribution volume in the candidate distribution parameter can not be greater than a sum of the gas demands of the end-users corresponding to the distribution pipeline.

In some embodiments, the gas company management platform of smart gas determines the assessment scores for the candidate distribution parameters based on the candidate distribution parameters, the end-user characteristics, and the pipeline characteristics profile using the peak regulation assessment model.

In some embodiments, the peak regulation assessment model is a machine learning model. In some embodiments, the peak regulation assessment model is a Convolutional Neural Network (CNN) model.

In some embodiments, an input of the peak regulation assessment model includes a candidate distribution parameter, the end-user characteristics, the pipeline characteristics profile, weather data, and the distribution demand sequence.

In some embodiments, an output of the peak regulation assessment model is an assessment score for the candidate distribution parameter.

In some embodiments, the peak regulation assessment model is obtained by training a training sample dataset, and a training process of the peak regulation assessment model includes an initial training phase and an intensive training phase. The initial training phase refers to a pre-training phase when the corresponding data of the target pipeline has not yet been accessed as training data, and the intensive training phase refers to a phase of personalization based specifically on the corresponding data of the target pipeline as the training data.

In some embodiments, the training data in the training sample dataset includes a training sample and a corresponding training label. In some embodiments, the training sample includes a sample peak regulation distribution parameter, sample end-user characteristics, a sample pipeline characteristics profile, sample weather data, and a sample distribution demand sequence; and the training label is a corresponding assessment score of the sample.

When training, the gas company management platform of smart gas inputs a plurality of training samples with training labels into an initial peak regulation assessment model, constructs a loss function by the training labels and results of the initial peak regulation assessment model, and iteratively updates parameters of the initial peak regulation assessment model based on the loss function by gradient descent or other ways. When a predetermined condition is met, the training of the peak regulation assessment model is completed and the trained peak regulation assessment model is obtained. The preset condition may be that the loss function converges, a count of iterations reaches a threshold, and so on.

The training sample dataset of the initial training phase is used in the initial training phase to train the initial peak regulation assessment model as described above, and the training sample dataset of the intensive training phase is used in the intensive training phase to train the initial peak regulation assessment model trained in the initial training phase as described above.

In some embodiments, the training labels are obtained by actually collecting actual feedback from end-users. For example, gas consumption experience, user complaint rate, productivity, etc., are used as the basis for scoring to determine an assessment score. For example, a corresponding monitoring device is used to obtain changes in product quality, stability of gas supply, production efficiency, etc., to assess the assessment score for the peak regulation distribution parameter.

In some embodiments of the present disclosure, the gas company management platform of smart gas determines the assessment scores of the candidate distribution parameters based on the candidate distribution parameters, the end-user characteristics, and the pipeline characteristics profile using the peak regulation assessment model, and then determines the peak regulation distribution parameter. By combining with the machine model, a more accurate peak regulation distribution parameter can be obtained, so that the operation of the distribution control device can be more in line with the actual demand.

In some embodiments, the gas company management platform of smart gas determines the peak regulation distribution parameter based on the assessment scores in multiple ways. For example, a candidate distribution parameter with a largest assessment score is determined as the peak regulation distribution parameter.

Step 440, generating the gas calling instruction based on the target calling parameter and sending the gas calling instruction to the smart gas equipment object platform to control the alternate gas source to supply gas inaccordance with the target calling parameter.

In some embodiments of the present disclosure, the initial calling parameter is uploaded to the smart gas government safety supervision management platform, the target calling parameter fed back by the smart gas government safety supervision management platform is obtained, the peak regulation distribution parameter of the distribution pipeline is determined, and the gas calling instruction is generated to realize real-time monitoring and processing by the government to reasonably regulate the gas distribution operation.

One or more embodiments of the present disclosure provide a non-transitory computer-readable storage medium, the storage medium storing computer instructions, and the computer executing the method for distribution controlling of the smart gas pipeline when the computer reads the computer instructions in the storage medium.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or characteristics may be combined assuitable in one or more embodiments of the present disclosure.

Furthermore, the recited order of processing elements or sequences, or the use of numbers, letters, or other designations, therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above maybe embodied in a hardware device, it may also be implemented as a software-only solution, e.g., an installation on an existing server or mobile device.

Similarly, it should be appreciated that in the foregoing description of embodiments of the present disclosure, various features are sometimes grouped together in a single embodiment, figure, or description thereof to streamline the disclosure aiding in the understanding of one or more of the various inventive embodiments. This method of disclosure, however, is not to be interpreted as reflecting an intention that the claimed object matter requires more features than are expressly recited in each claim. Rather, inventive embodiments lie in less than all features of a single foregoing disclosed embodiment.

In some embodiments, the numbers expressing quantities, properties, and so forth, used to describe and claim certain embodiments of the application are to be understood as being modified in some instances by the term “about,” “approximate,” or “substantially.” For example, “about,” “approximate” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes, excepting any prosecution file history associated with same, any of same that is inconsistent with or in conflict with the present document, or any of same that may have a limiting effect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

Finally, it should be understood that the embodiments described in the present disclosure are only used to illustrate the principles of the embodiments of the present disclosure. In closing, it is to be understood that the embodiments of the application disclosed herein are illustrative of the principles of the embodiments of the application. Thus, by way of example, but not of limitation, alternative configurations of the embodiments of the application may be utilized in accordance with the teachings herein. Accordingly, embodiments of the present application are not limited to that precisely as shown and described.

What is claimed is:

1. A method for distribution controlling of a smart gas pipeline, the method being performed by a gas company management platform of smart gas, comprising:
obtaining, through a gas company sensing network platform of smart gas, historical usage data of end-users of a target pipeline from a smart gas equipment object platform;
determining a distribution demand sequence based on the historical usage data;
generating a gas distribution instruction based on the distribution demand sequence and sending the gas distribution instruction to the smart gas equipment object platform to adjust a distribution control parameter of a distribution control device in the target pipeline; and
obtaining historical monitoring data and initial gas supply parameters of a gas supply source through the smart gas equipment object platform;
determining a gas consumption peak period based on the historical monitoring data;
in response to determining that a gas delivery time point is in the gas consumption peak period:
determining a peak regulation parameter for the target pipeline based on the distribution demand sequence and the initial gas supply parameters; and
generating a peak regulation distribution instruction based on the peak regulation parameter and sending the peak regulation distribution instruction to the smart gas equipment object platform to control the distribution control device in the target pipeline to carry out a distribution peak regulation operation in accordance with the peak regulation parameter.

2. The method according to claim 1, wherein the determining a distribution demand sequence based on the historical usage data includes:
obtaining, via a smart gas government safety supervision sensing network platform, end-user characteristics of end-users of the target pipeline from a smart gas government safety supervision management platform;
constructing a gas demand profile based on the historical usage data, the historical monitoring data, pipeline equipment data, the end-user characteristics, and weather data; and
determining the distribution demand sequence based on the gas demand profile by a demand determination model, the demand determination model being a machine learning model.

3. The method according to claim 2, wherein nodes of the gas demand profile include at least one of a pipeline node and a user node; and
node characteristics of the user node include a gas stabilization demand, the gas stabilization demand being determined based on the end-user characteristics and parameters of usage equipment.

4. The method according to claim 2, wherein the demand determination model is obtained by training based on a training sample dataset, and a training process of the demand determination model includes an initial training phase and an intensive training phase;
training data in the training sample dataset includes a training sample and a corresponding training label; the training sample includes a sample gas demand profile, and the training label includes a distribution demand sequence actually collected by the training sample at a sample future time; and
in the initial training phase, the training sample dataset is obtained based on general data on a cloud platform; and in the intensive training phase, the training sample dataset is obtained based on data actually collected from the target pipeline, a proportion of the training sample corresponding to a time period is no less than a preset threshold, and the preset threshold is positively related to a total amount of gas delivered in the time period.

5. The method according to claim 1, wherein the peak regulation parameter further includes a target calling parameter, and the peak regulation distribution instruction further includes a gas calling instruction;
the method further comprising:
determining an initial calling parameter based on the distribution demand sequence and the initial gas supply parameters;
uploading the initial calling parameter to the smart gas government safety supervision management platform, obtaining the target calling parameter fed back by the smart gas government safety supervision management platform;
determining a peak regulation distribution parameter of a distribution pipeline based on the target calling parameter and the initial gas supply parameters; and
generating the gas calling instruction based on the target calling parameter and sending the gas calling instruction to the smart gas equipment object platform to control an alternate gas source to supply gas in accordance with the target calling parameter.

6. The method according to claim 5, wherein the determining a peak regulation distribution parameter of a distribution pipeline based on the target calling parameter and the initial gas supply parameters includes:
determining a distribution priority based on the gas stabilization demand and an importance degree of a user; and
determining the peak regulation distribution parameter for the distribution pipeline based on the distribution priority, the target calling parameter, and the initial gas supply parameters.

7. The method according to claim 5, wherein the method further comprises:
determining, based on actual monitoring data, whether or not an actual distribution parameter and the peak regulation distribution parameter satisfy a preset discrepancy condition, and/or whether or not an actual calling parameter and the target calling parameter satisfy the preset discrepancy condition, during execution of the distribution peak regulation operation;
in response to determining that the actual distribution parameter and the peak regulation distribution parameter satisfy the preset discrepancy condition, and/or the actual calling parameter and the target calling parameter satisfy the preset discrepancy condition, generating a correction instruction based on the actual monitoring data, the actual distribution parameter, and the actual calling parameter; and
sending the correction instruction to the smart gas equipment object platform to correct an operating parameter of the distribution control device.

8. The method according to claim 5, wherein the determining a peak regulation distribution parameter of a distribution pipeline based on the target calling parameter and the initial gas supply parameters includes:
determining candidate distribution parameters based on the target calling parameter, the distribution demand sequence, and the initial gas supply parameters;
determining, using a peak regulation assessment model, assessment scores for the candidate distribution parameters based on the candidate distribution parameters, end-user characteristics, and a pipeline characteristics profile, the peak regulation assessment model being a machine learning model; and
determining the peak regulation distribution parameter based on the assessment scores.

9. An internet of things (IoT) system for distribution controlling of a smart gas pipeline, wherein the IoT system comprises a smart gas government safety supervision management platform, a smart gas government safety supervision sensing network platform, a smart gas government safety supervision object platform, a gas company sensing network platform of smart gas, and a smart gas equipment object platform configured on a same server or different servers respectively, the smart gas government safety supervision management platform includes a government supervision comprehensive database, and the smart gas government safety supervision object platform includes the gas company management platform of smart gas;
the smart gas government safety supervision object platform and the smart gas government safety supervision management platform exchange data via the smart gas government safety supervision sensing network platform; the smart gas government safety supervision object platform and the smart gas equipment object platform exchange data via the gas company sensing network platform of smart gas;
the gas company management platform of smart gas is configured to:
obtain, through the gas company sensing network platform of smart gas, historical usage data of end-users of the target pipeline from the smart gas equipment object platform;
determine a distribution demand sequence based on the historical usage data;
generate a gas distribution instruction based on the distribution demand sequence and send the gas distribution instruction to the smart gas equipment object platform to adjust a distribution control parameter of a distribution control device in the target pipeline; and
obtain historical monitoring data and initial gas supply parameters of a gas supply source, through the smart gas equipment object platform;
determine a gas consumption peak period based on the historical monitoring data;
in response to determining that a gas delivery time point is at the gas consumption peak period:
determine a peak regulation parameter for the target pipeline based on the distribution demand sequence and the initial gas supply parameters; and
generate a peak regulation distribution instruction based on the peak regulation parameter and send the peak regulation distribution instruction to the smart gas equipment object platform to control the distribution control device in the target pipeline to carry out a distribution peak regulation operation in accordance with the peak regulation parameter.

10. The IoT system according to claim 9, wherein the gas company management platform of smart gas is configured to:
obtain, via the smart gas government safety supervision sensing network platform, end-user characteristics of the end-users of the target pipeline from the smart gas government safety supervision management platform;
construct a gas demand profile based on the historical usage data, the historical monitoring data, pipeline equipment data, the end-user characteristics, and weather data; and
determine the distribution demand sequence based on the gas demand profile by a demand determination model, the demand determination model being a machine learning model.

11. The IoT system according to claim 10, wherein nodes of the gas demand profile include at least one of a pipeline node and a user node; and
node characteristics of the user node include a gas stabilization demand, the gas stabilization demand being determined based on the end-user characteristics, and parameters of usage equipment.

12. The IoT system according to claim 10, wherein the demand determination model is obtained by training based on a training sample dataset, and a training process of the demand determination model includes an initial training phase and an intensive training phase;
training data in the training sample dataset includes a training sample and a corresponding training label, the training sample includes a sample gas demand profile, the training label includes a distribution demand sequence actually collected by the training sample at sample future time;
in the initial training phase, the training sample dataset is obtained based on general data on a cloud platform; and in the intensive training phase, the training sample dataset is obtained based on data actually collected from the target pipeline, a proportion of the training sample corresponding to a time period is no less than a preset threshold, and the preset threshold is positively related to a total amount of gas delivered in the time period.

13. The IoT system according to claim 9, wherein the peak regulation parameter further includes a target calling parameter, and the peak regulation distribution instruction further includes a gas calling instruction;
the gas company management platform of smart gas is further configured to:
determine an initial calling parameter based on the distribution demand sequence and the initial gas supply parameters;
upload the initial calling parameter to the smart gas government safety supervision management platform, obtain the target calling parameter fed back by the smart gas government safety supervision management platform;
determine a peak regulation distribution parameter of a distribution pipeline based on the target calling parameter and the initial gas supply parameters; and
generate the gas calling instruction based on the target calling parameter and send the gas calling instruction to the smart gas equipment object platform to control an alternate gas source to supply gas in accordance with the target calling parameter.

14. The IoT system according to claim 13, wherein the gas company management platform of smart gas is further configured to:
determine a distribution priority based on the gas stabilization demand and an importance degree of a user; and
determine the peak regulation distribution parameter for the distribution pipeline based on the distribution priority, the target calling parameter, and the initial gas supply parameters.

15. The IoT system according to claim 13, wherein the gas company management platform of smart gas is further configured to:
determine, based on actual monitoring data, whether or not an actual distribution parameter and the peak regulation distribution parameter satisfy a preset discrepancy condition, and/or whether or not an actual calling parameter and the target calling parameter satisfy the preset discrepancy condition, during execution of the distribution peak regulation operation;
in response to determining that the actual distribution parameter and the peak regulation distribution parameter satisfy the preset discrepancy condition, and/or the actual calling parameter and the target calling parameter satisfy the preset discrepancy condition, generate a correction instruction based on the actual monitoring data, the actual distribution parameter, and the actual calling parameter; and
send the correction instruction to the smart gas equipment object platform to correct the operating parameter of the distribution control device.

16. The IoT system according to claim 13, wherein the gas company management platform of smart gas is further configured to:
determine candidate distribution parameters based on the target calling parameter, the distribution demand sequence and the initial gas supply parameters;
determine, using a peak regulation assessment model, assessment scores for the candidate distribution parameters based on the candidate distribution parameters, end-user characteristics, and a pipeline characteristics profile, the peak regulation assessment model being a machine learning model; and
determine the peak regulation distribution parameter based on the assessment scores.

17. A non-transitory computer-readable storage medium, wherein the storage medium stores computer instructions, and when a computer reads the computer instructions in the storage medium, the computer performs the method of claim 1.
